(19) United States
(12) Patent Application Publication
(10) Pub. No.: US 2010/0058006 A1
(43) Pub. Date: Mar. 4, 2010

(54) DOCUMENT CACHING FOR MULTIPLE CONCURRENT WORKFLOWS

(76) Inventors: Raghvendran Murthy, Bangalore (IN); Pankaj Gulhane, Maharashtra (IN)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/198,363

(22) Filed: Aug. 26, 2008

(51) Int. Cl. G06F 12/00

(52) U.S. Cl. 711/156; 711/E12.001

(57) ABSTRACT

Techniques are provided for leveraging the abstraction of a document set to provide optimal throughput across document accessors when multiple document accessors are accessing the same document set. According to one aspect, the document accessors are not restricted to accessing documents in any particular document order. Rather, the state of each document accessor is maintained using the bitmaps, and an efficient cyclic array based data structure is used to track the document access-count state. Based on this information, the fetch order of the documents is determined dynamically, to maximize the cache hit rate experienced by the document accessors.

### FIELD OF THE INVENTION

The present invention relates to document caching and, more particularly, to caching documents that are accessed by multiple concurrent workflows.

### BACKGROUND

In information extraction pipelines, there are often scenarios where a particular document set needs to be processed by multiple pipeline modules. When there are no data dependencies, the modules can be executed concurrently.

FIG. 1 is a block diagram of such a scenario. Referring to FIG. 1, a document set 102 is stored on a document store 104. The mechanisms used to fetch/access documents in the document set 102 from document store 104 are referred to herein as document accessors 106. FIG. 1 illustrates three document accessors 108, 110 and 112. Document accessors 108, 110, and 112 fetch documents from document store 104 in response to calls from modules that process the documents (shown as DA Users 122).

Typically, each DA User will simply repeatedly request the “next” document from its respective document accessor, until all documents within the document set have been fetched by the document accessor and processed by the DA User. It is up to each document accessor to determine which specific document to fetch in response to a “next” call from a DA User.

The act of accessing a document from the document store 104 necessarily involves a disk and/or a network operation, and is costlier than the document access from the memory by several orders of magnitude. To reduce the cost, it is possible to store copies of fetched documents in a cache buffer 120. Once one document accessor has fetched a copy of a document into cache 120, the other document accessors can fetch the same document from the cache 120, rather than from the document store.

While caching is known to improve performance in information extraction pipelines, the order in which each document accessor fetches documents has a significant effect on the performance of the system. For example, assume that document set 102 includes 1000 documents. Assume further that each of document accessors 106 start fetching documents in order starting at document 1. Under these conditions, the number of cache “hits” experienced by the document accessors 106 will start out relatively high. In contrast, if document accessors 108, 110 and 112 start fetching documents in order beginning at documents 1, 600 and 1200, respectively, then the document accessors 106 will experience very few cache hits.

Even when document accessors start out fetching the same documents in the same order, the fetches being performed by document accessors may become out of sync with each other, thereby resulting in performance degradation over time. For example, if the “fastest” document accessor gets too far ahead, then the documents fetched into cache by the fastest document accessor may be replaced in cache before they are requested by other document accessors. Consequently, when the other document accessors finally request the documents, the documents must be loaded once again from disk into the cache 120.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a system in which multiple document accessors are accessing documents from a document store;

FIG. 2 is a block diagram of data structures that may be used to track the least-accessed and most-accessed documents during a session, according to an embodiment of the invention; and

FIG. 3 is a block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

The techniques described herein involve a caching mechanism that leverages the abstraction of the document set to provide optimal throughput across the document accessors 106 when more than one document accessors 106 access the same document set 102. The extractors could be extracting entities of the same or of different types.

According to one embodiment, document accessors 106 are not restricted to accessing documents in any particular document order. Rather, the state of each document accessor is maintained using the bitmaps, and an efficient cyclic array based data structure is used to track the document access-count state. Based on this information, the fetch order of the documents is determined dynamically, to maximize the cache hit rate experienced by the document accessors.

### Selecting Least-Accessed Documents

According to one embodiment, when the cache does not contain any document that has not already been fetched by a document accessor, the document accessor fetches into cache a “least-accessed” document. In this context, the least-accessed document is a document that has been previously provided to the fewest number of document accessors that are participating in the current session. The number of document accessors that have previously fetched a particular document in the current session is referred to herein as the “access-count” of the particular document.

As an example, assume that twenty document accessors are participating in a current session, and that a particular document accessor X is asked to fetch a document that document accessor X has not previously fetched. Assume further that document accessor X has already fetched all documents from the relevant document set except for documents A, B and C. Finally, assume that none of documents A, B and C currently reside in the cache, and that documents A, B and C have access-counts of 18, 7 and 2, respectively.

To fetch a not-previously-provided document, document accessor X must load into cache one of documents A, B or C. To determine s which of documents A, B, and C to load into cache, document accessor X determines which of documents A, B, and C is currently the least-accessed document. Since document C has the lowest access-count, document accessor X will fetch document C into cache.

### Replacing Most-Accessed Documents

As document accessors load documents into cache, the cache will eventually fill up. Once a cache is full, loading new documents into cache will involve replacing within the cache documents that were previously loaded into the cache. The performance of a cache system can be significantly affected by which documents are selected for replacement. According to one embodiment, the selection of documents to replace in cache is based on access-count of the documents. Specifically, in one embodiment, the cached document with the highest access-count is selected for replacement. The cached document with the highest access-count is referred to herein as the “most fetched” document.

### API to Document Accessors

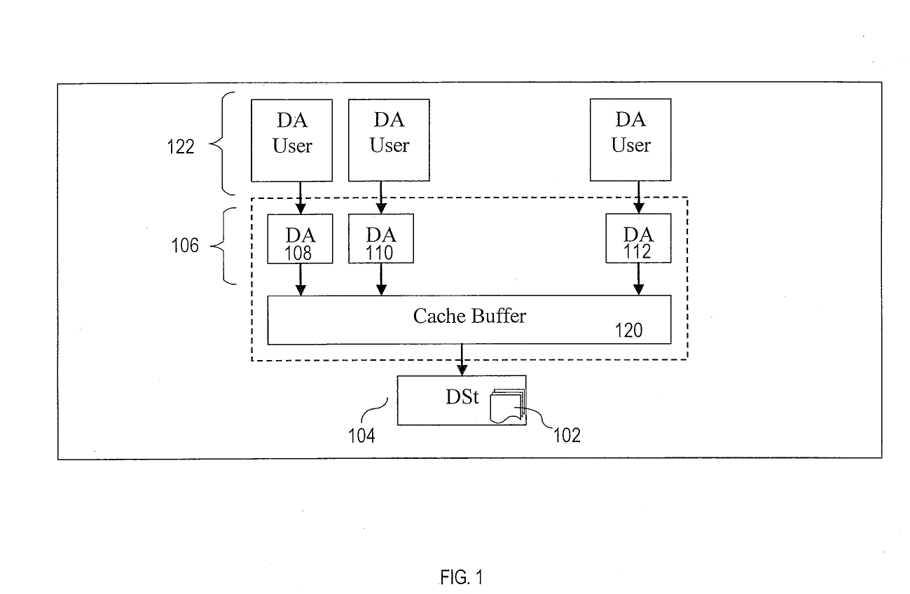

Referring again to FIG. 1, a system is provided in which documents from a document set 102 are accessed by the pipeline modules (DA users 122) using document accessors 106. According to one embodiment, each document accessor implements an ‘iterator’ that provides methods to access the individual documents. Specifically, in one embodiment, the API provided by document accessors includes the methods “hasNext( )” and “next( )”. The hasNext( )method tells the caller if documents are available. Thus, a document accessor will return “true” to all calls to the hasNext( ) method until the document accessor has iterated through all documents in the document set 102.

The next( ) method returns the “next” document from the document set 102. However, as explained above, the document that is selected as the “next” document by a particular document accessor is determined dynamically, rather than based on any pre-defined order. Specifically, each particular document accessor attempts to fill a “next( )” call with a document that (a) currently resides in cache 120, and has not previously been provided by the particular document accessor. If all documents that currently reside in cache 120 have previously been provided by the particular document accessor, then that document accessor loads into cache 120 the least-accessed document that (1) does not currently reside in cache, and (2) has not previously been provided by the particular document accessor.

According to one embodiment, each document accessor has an associated state that identifies which of the documents in the document set 102 have been returned by the document accessor to the user.

### The Cache

According to one embodiment, cache buffer 120 is organized as slots. Specifically, in one embodiment, the cache buffer 120 has a fixed number of slots, and each slot stores a document. As shall be described in greater detail hereafter, state information is maintained for tracking the slots of cache buffer 120.

### System Operation

In one embodiment, each of DA Users 122 repeatedly calls the next( ) method of a document accessor to obtain and process the documents in the document set 102. Each document accessor returns the next unprocessed document, from its own perspective, from the document set 102. Specifically, in response to a call to its next( ) method, each document accessor attempts to identify to its user a previously-un-served document that is present in the cache. If such a document is present, then the document accessor returns the document and updates the relevant state to indicate that the document was provided.

If no such document is found in cache, then the document accessor identifies the most useful un-served document to be fetched, fetches the identified document from the document store 104, and places the document in a cache slot. In one embodiment, the “most useful” un-served document is the document that has the lowest access-count. If no cache slots are free to load the most useful un-served document into cache, a cache slot is replaced using a replacement policy, and the document thus retrieved is returned to the DA user that initiated the next( ) call.

### Caching System Characteristics

For the purpose of explanation, it is assumed that the number of document accessors 106 will be fixed for a given session and a document set 102. Further, as mentioned above, the document order to be served to any particular DA User is not specified, but is determined by the caching system on the fly. The order of documents provided to a DA User on the successive next ( ) calls is determined by the documents present in the cache buffer at the call time.

According to one embodiment, if more than one document in cache is eligible to be returned to a next( ) call, then which of the eligible cached documents is returned is arbitrary. If no document is available in the cache, or all the documents present in the cache have already been served, then the next document to be fetched is determined by the least-accessed policy. The least-accessed document would then be most useful for subsequent next( ) calls received by other document accessors in the session.

When a new document is brought into cache 120 from document store 104, a document to be replaced is determined by the most-accessed policy. Replacing the most-accessed document is desirable because the most-accessed document will be accessed the least number of times in the future, since the number of document accessors 106 for any given session is fixed.

### Data Types for Implementing Policies

As explained above, embodiments are provided in which document accessors first search for not-previously-accessed documents in cache. In this case, a “not-previously-accessed” is a data-accessor-specific. Thus, a particular document may be “not-previously-accessed” to document accessor X, even though that particular document has been accessed by one or more of the other document accessors during the session.

If the cache currently does not store any not-previously-accessed documents for a particular document accessor, then a document is loaded into cache based on a least-accessed policy. If necessary to load the least-accessed document, a document that resides in cache is selected for replacement based on a most-accessed policy. Various mechanisms may be employed to determine whether a cache contains not-previously-accessed documents for specific document accessors, and for identifying least-accessed and most-accessed documents. These policies are not limited to any particular mechanisms for making these determinations.

For the purpose of explanation, it shall be assumed that the session involves a document set with N documents, a set of K document accessors 106, and a cache buffer with M slots. For the purpose of describing one possible mechanism, the following terms shall be used:
Document number—a continuous but arbitrary sequence number starting from 0 assigned to every document in the document set. The number is valid for an incarnation of the document set.
Document id—an opaque id used to persistently identify a document. The document store stores a document's content against this id.
Document access-count—For a particular incarnation (session) of the document set and the associated document accessors 106, the number of times a particular document has been accessed.
Cache slot index—The index to the cache slot related meta-information.

According to one embodiment, the data types used to facilitate the operation described above include BitMap, Heap, and a Min/Max tracker. A BitMap may be implemented as a linear array of bits, and is used to track the document status. The nth bit represents the document in the document set with the document number n. A Heap may be implemented as a max-heap using a binary tree.

The Min/Max tracker is a data type for tracking, among a set of counters, those counters with maximum or minimum values. Each counter represents the access-count on a particular document and gets incremented on each access. According to one embodiment, the Min/Max tracker efficiently handles the case when the set membership is dynamic.

According to one embodiment, the Min/Max tracker is implemented using various arrays, including a Straight array and a Cyclic array. The specific structures and operation of one embodiment of the Min/Max tracker shall be described in greater detail hereafter. In general, the data structure assumes that the counters are arranged as arrays, and the array elements have a field called ‘cycle index’ that is manipulated by the data structure access methods.

### Data Structures for Implementing Policies

According to one embodiment, the data types described above are used to instantiate data structures to maintain the state of the caching system. According to one embodiment, the data structures used to maintain state in a session includes a document map, a cache state bitmap, an array of DA access bitmaps, a fastest DA tracker, a cache slot state array, and a document-in-slot access tracker. Each of these structures shall be described hereafter.

The Document Map: According to one embodiment, the document map is a table ordered as per the document-number. In one embodiment, the document map has the following fields: Document number, Document id, Document access-count, Cache slot id.

The Cache State Bitmap: The cache state bitmap is of type BitMap, and is a per document set structure. Within the cache state bitmap, a bit is set if the corresponding document is in a cache slot. Thus, if there are N documents in the document set 102, and only documents 5 and 7 currently reside in cache 120, then the cache state bitmap will be a string of N bits, where only bits 5 and 7 are set.

The Array Of DA Access Bitmaps: The array of DA access bitmaps includes one DA access bitmap per document accessor. Thus, in the session shown in FIG. 1, the array has three entries—one for each of document accessors 108, 110 and 112. Each of the array entries includes a “documents served” counter, and a DA access bitmap.

The DA access bitmap is a per document accessor structure. Within the DA access bitmap of a given document accessor, a bit is set if the corresponding document is required to be served to DA User associated with the given document accessor. For example, if document accessor 108 has already provided documents 1 and 3 to its DA User, then all bits except bits 1 and 3 of the DA access bitmap of document accessor 108 would be set.

The documents served counter for each document accessor tracks the number of documents that have already been served through that document accessor. The Fastest DA tracker tracks all these counters.

The Fastest DA Tracker: According to one embodiment, the fastest DA tracker is of type Heap, and is implemented as a max-heap using a binary tree. The fastest DA tracker tracks the current fastest document accessor in terms of number of documents processed. Thus, if document accessors 108, 110 and 112 have served 50, 300 and 200 documents, respectively, then fastest DA tracker would indicate that document accessor 110 is the current “fastest DA”.

The fastest DA tracker is used to answer queries such as ‘give the document accessor which has processed most number of documents’. The counter for the document accessor which has finished processing all the documents is reset to −1.

The Cache Slot State Array: According to one embodiment, the cache slot state array is an array of cache slot state elements. A cache slot state element, in turn, stores a Handle to the memory location where the document content is stored, and an index into the Document-in-slot Access tracker.

For example, cache slot 3 may currently store document 7. Under these circumstances, entry 3 in the cache slot state array would include a Handle to the memory location where the content of document 7 is stored.

Document-In-Slot Access Tracker: According to one embodiment, the Document-in-slot Access tracker is of type Min/Max tracker, which shall be described in greater detail hereafter. The Document-in-slot Access tracker tracks the access-count of the current documents in the cache slots. The Document-in-slot Access tracker is used to answer queries like ‘insert a new counter by replacing the counter containing max value’. According to one embodiment, an index is also provided into the Document-in-slot Access tracker.

### Use of Data Structures During Operation

The data structures described above may be used to implement the least-accessed/most-accessed policies to achieve improved cache hit ratio during a session in which multiple document accessors are processing documents from a document set. Specifically, in response to a call to the next( ) procedure, a document accessor may perform a logical AND between its DA_access_bitmap and the cache_state_bitmap, as follows:

cache_available_bitmap=DA_access_bitmap & cache_state_bitmap

The resulting cache_available_bitmap indicates which documents (1) have not yet been processed by the document accessor, and (2) are currently in cache. After the cache_available_bitmap has been computed, the cache_available_bitmap may be fed to a get_first_setd_bit function to determine which cached document to fetch next. This operation is illustrated as follows:

document_number=get_first_set_bit(cache_available_bitmap)

The get_first_set_bit returns the position of the first bit set in ‘cache_available bitmap’. If such a position ‘n’ is available, then the document accessor indexes ‘n’ into the Document map and gets the cache slot id ‘csID’. The cache slot id indicates the cache slot in which document n is stored. Once the cache slot id is determined, the document accessor gets the cache buffer by indexing ‘csID’ into Cache Slot state array.

In response to the access of document n, the document accessor updates the states in Fastest DA tracker and Document-in-slot Access tracker, to record the fact that document n was accessed by the document accessor.

If no bits of cache_available_bitmap are set, then the document accessor uses the least-accessed document fetch policy to get the most useful document into the cache.

### The Least-Accessed Document Fetch Policy

As explained above, it is desirable to load into cache the document that will most accessed after the document has been loaded into cache. The more a document has already been accessed, the fewer times it will be accessed in the future. Therefore, the document that will be most access is the document that has been the least accessed. Ideally, identifying the document that has been least accessed would involve taking the intersection of the un-fetched document set among all the document accessors 106. However, performing such an intersection may not be cost effective. Therefore, according to one embodiment, an approximation approach is used.

Specifically, assuming that the document accessors maintain their pace of execution almost the same through the session, it will be the case that the documents un-served by the fastest document accessor will also be un-served for all the other document accessors. An approach is described hereafter that provides a useful heuristic to identify the least-accessed documents to be put into the cache.

Unless the current document accessor is the fastest document accessor, there will still be un-served documents in the current document accessor that have been served by the current fastest document accessor. The following logic can be used to identify one of those documents:

```
fastest_DA = DA_Array[Fastest_DA_tracker.getMax( )]
common_doc_bitmap = fastest_DA & DA_access_bitmap
if (common_doc_bitmap != 0)
  document_number = get_first_set_bit(common_doc_bitmap)
else
  document_number = get_first_set_bit(DA_access_bitmap)
return document_number
```

Based on this logic, a document will be selected which has not yet been served to either the document accessor that is performing the fetch, nor the “fastest” document accessor. If the document accessor that is performing the fetch is the fastest document accessor, then the logic simply selects the first document that has not yet already been fetched by the document accessor. Once such a document is identified, it is loaded into cache.

If a document is to be loaded into cache, and all the cache slots are full, then the document accessor uses the cache replacement policy to replace least useful document (the most-accessed document) in the cache with the current document.

### Cache Replacement Policy

It is desirable to replace the least useful document currently in the cache slots with the most useful document, as identified in the document-fetch policy. In one embodiment, the most-accessed policy is used because the most-accessed document will be least accessed in the future, as the number of document accessors in any given session are fixed. According to one embodiment, the policy may be implemented according to the following logic:

document_number = document_fetch_policy( )
slot_number = document_in_slot_access_tracker.remove( )
document_in_slot_access_tracker.insert(slot_number,
current_access_count)

As shall be explained in greater detail below, the access-count states are updated in the Document map, DA access bitmap, Fastest DA tracker and Document-in-slot Access tracker after every access.

### The Min/Max Tracker

The “Min/Max tracker” generally refers to the mechanism used by document accessors to track and identify the current least-accessed document, and the current most-accessed document, according to an embodiment of the invention. According to one embodiment, the Min/Max tracker is implemented using a variety of data structures, including a Straight array, a Cycle array, a Headers array, and an AccessCount array. In one embodiment, these data structures are defined as follows:

| | |
|---|---|
| Array straight[M]; | // Contains cyclic indices |
| CyclicArray cycle[M]; | // Contains straight indices |

CyclicCounter headers[K+1] // K bins, can take value from 1−M
maintains condition headers[i] C>= headers[i−1]; 0th bin for free slots
Array accessCount[M];

The AccessCount Array: The AccessCount array includes one array entry for each document slot. The order of the AccessCount array corresponds to the order of the document slots. For example, AccessCount[1] corresponds to document slot 1, AccessCount[2] corresponds to document slot 2, etc. The contents of the AccessCount entry for a document slot is the number of times the document currently within the document slot has been accessed in the current session. Thus, if document 20 resides in document slot 4, and document 20 has been accessed 10 times, then the value in AccessCount[4] would be 10.

The Straight Array: The Straight array also includes one array entry for each document slot. Similar to the AccessCount array, the sequence of the entries within the Straight array corresponds to the order of the document slots. Thus, Straight[1] corresponds to document slot 1, Straight[2] corresponds to document slot 2, etc. The contents of the Straight array entry for a document slot indicates the index value of the Cycle array entry for the document slot. For example, if the Cycle array entry for document slot 4 is the tenth entry in the Cycle array, then Straight[4] would equal 10. Thus, the Straight array is used for locating entries within the Cycle array based on the numbers of the document slots to which the Cycle array entries correspond.

The Cycle Array: The Cycle array includes an array entry for each document slot. The Cycle array entry for a given document slot stores the value of the document slot. For example, if the fifth entry of the Cycle array is associated with document slot 10, then Cycle[5] would store the value 10. The order of the cycle array entries corresponds to the times the corresponding document was accessed. The cycle array is partitioned into different bins by header pointers. In the cyclic array, these bins are sorted in decreasing order. Thus, the array entries in the highest bin of the cycle array are for the most-frequently accessed documents, while the array entries in the lowest bin of the cycle array are for the least-frequently accessed documents.

The Headers Array: As mentioned above, header pointers delimit buckets within cyclic array. Thus, in one embodiment, all non-accessed candidates will be stored from header[0] to header[1] in the cycle array. Similarly, all candidates which were accessed once will be stored from header[1] in the cycle array to header[2] and so on. Header[MAX] will always point to the bin with candidates which were accessed maximum number of times. Here, MAX is maximum number of times any element will be accessed (which will be equal to the number of DAs). The Headers array includes one entry for each bin of the cycle array. The content of each Headers entry is an index into the Cycle array. The sequence of the Headers array entries corresponds to the accesses counts from highest to lowest. Thus, Headers[0] includes an index value that points to the Cycle array entry for the document with the lowest access-count, while Headers[K] corresponds to the document with the highest access-count. The value stored in Headers array entries are indexes into the Cycles array. Thus, Headers[0] will return the index value of the Cycle array entry for the document that has the lowest access-count. Headers[K] will return the index value of the Cycle array entry for the document that has the highest access-count.

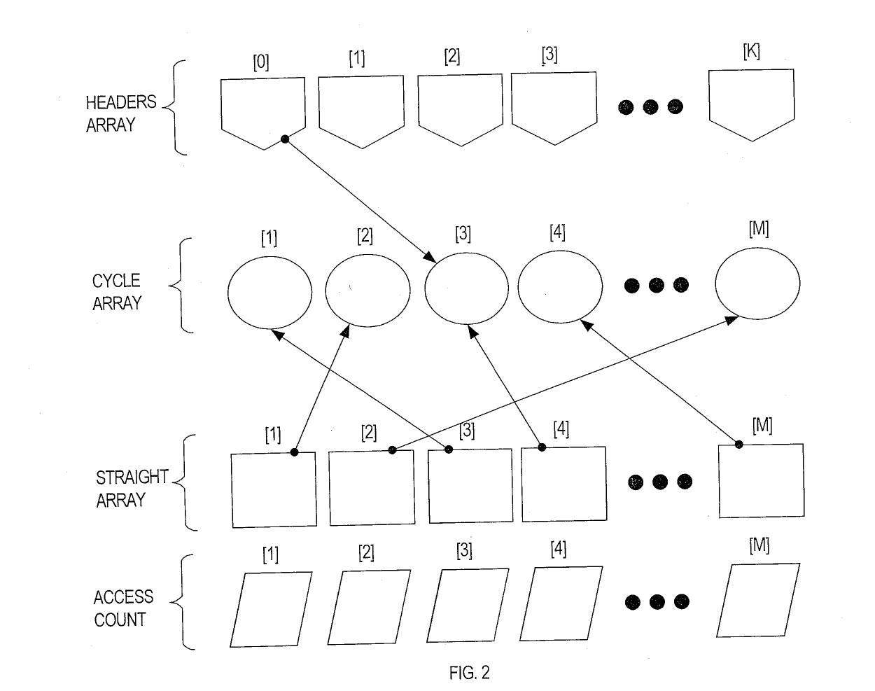

FIG. 2 is a block diagram illustrating the various data structures described above. As illustrated in FIG. 2, header[0] points to cycle array entry 5, thereby indicating that free slots in cycle array are available beginning at index 5. Header[1] points to cycle array entry 3, thereby indicating that elements present in cycle slots 3, and 4 have been accessed one time. Similarly, header[2] points to cycle array entry 1, thereby indicating that elements present in cycle array slots 1 and 2 have been accessed 2 times. Header[3] points to cycle array 0. All headers from 3 to MAX are also pointing to cycle array slot 0. This indicates that the most-accessed element in the cycle array can obtained by querying header[MAX].

In the example illustrated in FIG. 2, straight array element 3 points to cycle array element 0. Since cycle array element 0 is the most-accessed element, it can be determined that the most accessed element resides in document slot 3. Further, the access count entry 3 will indicate exactly how many times the document in slot 3 has been accessed.

### The Insert Procedure

The Insert procedure is called every time a document is fetched into the cache. According to an embodiment of the invention, the Insert procedure may be implemented using the following logic:

```
insert idx
  straight[idx] = headers[0];
  cycle[headers[0]] = idx;
  header[0]++;
  accessCount[idx]=1;
END insert
```

Whenever document is fetched into the cache, the entry for the document is inserted into the first unused position in the cycle array. The first unused position in the cycle array is indicated by headers[0]. After the entry has been inserted, into the cycle array, the headers[0] pointer has to be incremented to point to the next unused position. By moving the headers[0] pointer back one position, the newly used cycle array entry ceases to belong to the bin indicated by the headers [0] pointer, and instead becomes a member of the bin indicated by the headers[1] pointer. The number of accesses is initialized to 1.

### The Increment Procedure

The Increment procedure is called every time a document is accessed from the cache. According to an embodiment of the invention, the increment procedure may be implemented using the following logic:

```
increment idx
  count <- accessCount[idx]; # get count associated with idx present in
cache
  one <- straight[idx];
  two <- headers[count]
  swap(cycle[one], cycle[two]);
  swap(straight[cycle[one]], straight[cycle[one]]);
  # AS this is only increment operation, it will switch from k−1 to k, so
no need to adjust other variables
  header[count] <- header[count]+1;
  accessCount[idx]++;
END increment
```

Whenever the increment procedure is invoked, the position of the cycle array entry for the document is shifted from its current bin in the cycle array (the “old bin”) to the next higher bin in the cycle array (the “new bin”). In one embodiment, this shifting is performed by first moving the cycle array entry to the top of the old bin, and then incrementing the header pointer of the old bin. Incrementing the header pointer of the old bin effectively places the cycle array entry at the top of the old bin into the new bin.

Specifically, assume that before the access, the cycle entry for the document was in the bin indicated by header[x]. Consequently, after the access, the cycle array entry for the document must move into the bin indicated by the header[x+1]. Moving the cycle entry between bins in this manner may be achieved by (1) retrieving the position of the document in the cycle array, (2) swapping the cycle array entry with the cycle array entry indicated by the header pointer of the old bin, and (3) incrementing the header pointer for the old bin. A similar process is used to rearrange pointer positions in straight array. Finally, the accessCount of slot containing the document that was accessed is incremented (accessCount[idx]++).

### The Remove Procedure

The Remove procedure is an example of how a cached document may be selected for replacement, according to an embodiment of the invention. Typically, the remove procedure will be called when all slots in the cache are full, and a document that is not currently in cache needs to be loaded into cache. The logic of one implementation of the Remove procedure is illustrated in the following code:

```
remove
  temp <- cycle[headers[K]]
  count <- headers[K];
  counter <- MAX;
  LOOP1:
  if(counter>=0 && headers[counter]==counterValue)
      headers[counter]++;
  else
      goto END_LOOP1
  END_LOOP1
  remove <- temp
END remove
```

This example code is invoked when removing maximum accessed page. To remove a maximum accessed page, header[MAX]++ is incremented so that it will point to the next element in the cycle array. This effectively places the cycle entry that was at header[MAX] into the unused bin indicated by header[0]. This method can also be used when retrieving an element with some ‘k’ accesses. Under these circumstances, header pointers from ‘k’ to ‘MAX’ must be incremented, as coded in the above example.

### The GetMax Procedure

The GetMax procedure is an example of how to determine the current “most-accessed” document using the Min/Max data structures described above. The logic of one implementation of the GETMAX procedure is illustrated in the following code:

getMax
getMax <- cycle[headers[K]];
END getMax

In this example code, “headers[K]” retrieves the value contained in the Kth entry of the Headers array. As explained above, the Kth entry of the headers array will contain an index value that specifies the entry, within the Cycle array, of the “most-accessed” document that is currently cached. This index value is used to index into the Cycle array, to extract the document id of the most-accessed document.

### Hardware Overview

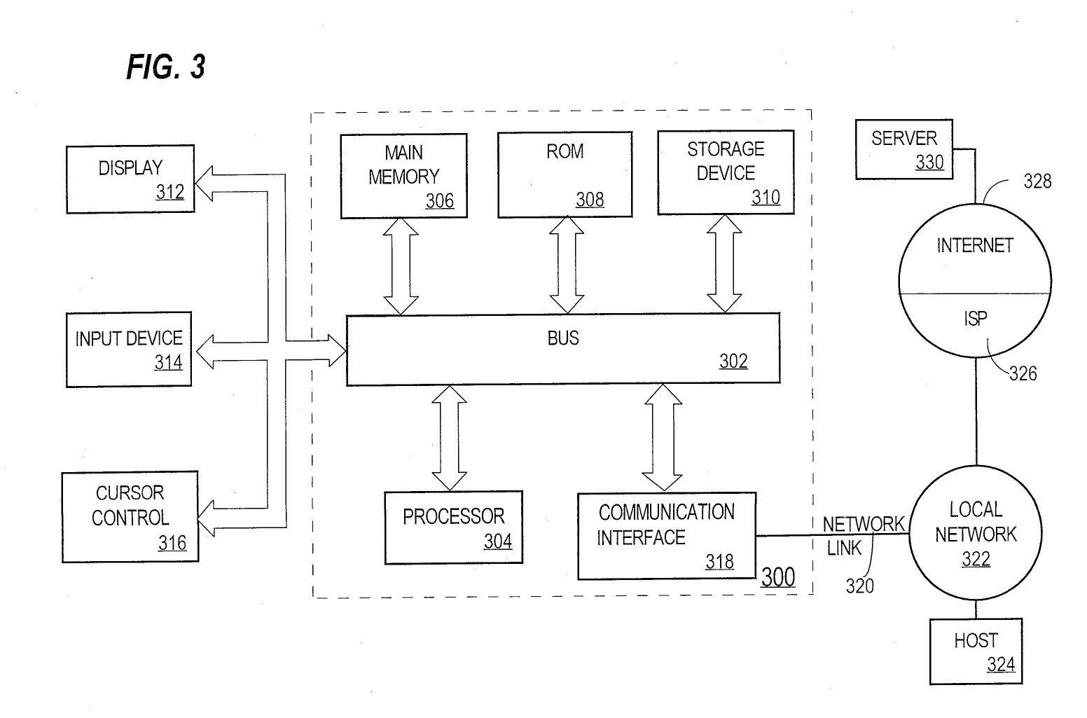

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to storage media and transmission media. Storage media includes both non-volatile media and volatile media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for accessing documents, comprising:
receiving from a component a request for any document, from a document set that is stored on a document store, that was not previously provided to the component;
in response to the request, performing the steps of:
performing a comparison between (a) first information that indicates which documents have been previously provided to the component and (b) second information that indicates which documents currently reside in a cache;
based on the comparison, determining that the cache includes a document that was not previously provided to the component;
in response to determining that the cache includes a document that was not previously provided to the component, performing the steps of
fetching the document from the cache;
providing the document to the component; and
updating the first data to indicate that the document was provided to the component.

2. The method of claim 1 further comprising:
receiving from said component a second request for any document, from said document set that is stored on said document store, that was not previously provided to the component;
in response to the second request, performing the steps of:
performing a second comparison between (a) first information that indicates which documents have been previously provided to the component and (b) second information that indicates which documents currently reside in a cache;
based on the comparison, determining that the cache does not include any document that was not previously provided to the component;
in response to determining that the cache does not include any document that was not previously provided to the component, performing the steps of
identifying a least-accessed document of those documents that have not previously been provided to said component;
fetching the least-accessed document from the document store;
providing the least-accessed document to the component; and
updating the first data to indicate that the least-accessed document was provided to the component.

3. The method of claim 2 wherein:
the component is one of a plurality of components that are accessing the documents during a session; and
the step of identifying a particular document that is least-accessed includes:
identifying a currently-fastest component from the plurality of components, wherein the currently-fastest component is the component, of the plurality of components, that has accessed the most documents during the session;
identifying a document that (a) is not in the cache, (b) has not been accessed by the component, and (c) has not been accessed by the currently-fastest component.

4. The method of claim 2 further comprising making space available in said cache for said particular document by:
identifying a most-accessed document within said cache; and
within said cache, replacing said most-accessed document with said least-accessed document.

5. A method for tracking accesses to documents, comprising:
maintaining a cycle array of cycle array entries, wherein each cycle array entry corresponds to a document;
ordering entries in the cycle array entry in an order that reflect how many times the documents associated with the entries have been accessed;
maintaining a header array of header array entries, wherein each header array entry is an index into the cycle array, and establishes the start of a bin of cycle array entries;
wherein all cycle array entries within each bin correspond to documents that have been accessed the same number of times;
in response to a document being accessed, moving the cycle array entry associated with the document from a first bin to a second bin.

6. The method of claim 5 wherein moving the cycle array entry includes:
swapping the cycle array entry with the cycle array entry that is currently at the head of the first bin; and
incrementing the header point that marks the beginning of the first bin.

7. The method of claim 5 wherein:
the header array includes a first header array entry that indicates the beginning of a bin that contains documents accessed the highest number of times; and
the method further comprises using the first header array entry to select which document, of a plurality of cached documents, to remove from cache.

8. The method of claim 7 further comprising, in response to removing from cache a document associated with the cycle array entry pointed to by the first header array, incrementing the first header array entry to cause the first header array entry to point to a next cycle array entry.

9. A computer-readable storage medium storing one or more sequences of instructions which, when executed by one or more processors, causes the one or more processors to perform the method recited in claim 1.

10. A computer-readable storage medium storing one or more sequences of instructions which, when executed by one or more processors, causes the one or more processors to perform the method recited in claim 2.

11. A computer-readable storage medium storing one or more sequences of instructions which, when executed by one or more processors, causes the one or more processors to perform the method recited in claim 3.

12. A computer-readable storage medium storing one or more sequences of instructions which, when executed by one or more processors, causes the one or more processors to perform the method recited in claim 4.

13. A computer-readable storage medium storing one or more sequences of instructions which, when executed by one or more processors, causes the one or more processors to perform the method recited in claim 5.

14. A computer-readable storage medium storing one or more sequences of instructions which, when executed by one or more processors, causes the one or more processors to perform the method recited in claim 6.

15. A computer-readable storage medium storing one or more sequences of instructions which, when executed by one or more processors, causes the one or more processors to perform the method recited in claim 7.

16. A computer-readable storage medium storing one or more sequences of instructions which, when executed by one or more processors, causes the one or more processors to perform the method recited in claim 8.
